(19) United States
(12) Patent Application Publication
(10) Pub. No.: US 2012/0135361 A1
(43) Pub. Date: May 31, 2012

(54) GRATE COOLER PLATE HAVING ADJUSTABLE INSERT

(75) Inventor: Dieter Brendler, Bergisch Gladbach (DE)

(73) Assignee: KHD HUMBOLDT WEDAG GMBH, Köln (DE)

(21) Appl. No.: 13/389,156

(22) PCT Filed: Aug. 3, 2010
(86) PCT No.: PCT/EP10/61280

§ 371 Date: Feb. 6, 2012

(30) Foreign Application Priority Data
Aug. 7, 2009 (DE) 20 2009 010 711.6

(51) Int. Cl. F27D 15/02

(52) U.S. Cl. 432/77

(57) ABSTRACT

A grate cooler plate including an air inlet and air passage openings through which the air flows for cooling the cooling goods present on the grate cooler plate. A rotatable insert having air passage openings is located in an upper surface of the grate cooler plate. The effect of the grate plate is that bulk goods placed in the inlet region of a grate plate cooler expand out to a flat cone of bulk goods.

The invention relates to a grate cooler plate comprising an air inlet and air passage openings through which flows air for cooling the cooling stock lying on the grate cooler plate.

For the cooling of hot cooling stock, for instance of fresh clinker emanating from a rotary kiln, this is deposited onto a movable cooling grate which transports the cooling stock from the end of the rotary kiln to a cooler outlet and at the same time forces cooling air through the cooling stock layer lying on the cooling grate. As the cooler, step grate coolers, traveling grate coolers, but also coolers which work according to the so-called “walking floor” principle, hereinafter referred to as walking floor coolers, can be used. If the cooling stock is deposited on the cooling grate via a rotary kiln or via a bulk pile, then a conical pile, which by the transport action of the cooler is distended into a pile with a roof-like surface, is normally formed. This pile shape prevents cooling air which passes from below through the cooling grate from flowing evenly through the cooling stock layer. Instead of flowing evenly through the cooling stock, most of the cooling air flows through the grate and through the cooling stock at those places at which the layer thickness of the bulk material layer on the cooling grate is particularly small and the cooling air therefore has little resistance to overcome when penetrating this bulk material layer. Hence the heat of the cooling stock is not optimally absorbed by the cooling air and the cooling air which passes out of the cooling stock to be cooled is, in its entirety, unnecessarily cold as a result of the cooling air which flows past the sides of the roof-shaped cooling stock bed. For ideal use, the cooling air should absorb as much heat as possible and, at same time, itself be strongly heated in order to feed this air for recuperation back to the upstream deacidification and sintering process. The higher the temperature of the cooling air, the greater the efficiency of the heat recovery which is intended to be achieved by the recuperation.

In order to prevent the formation of a conical pile in the inlet zone of such coolers, rakes which spread the cooling stock evenly over the surface of the cooler are frequently used. Other coolers have in the inlet zone outwardly pointing, vertical baffle plates on the cooler surface in order to transport the cooling stock in the inlet region evenly outward in order thus to broaden the pointed roof shape of the bulk pile and thereby even out the cooling stock on the cooling grate in terms of its layer height.

All solutions for mechanically spreading the hot cooling stock, in particular the hot clinker, have the drawback, however, that a used rake, vertical baffle plates or slides are subjected to very heavy wear, since the clinker is not only very hard and strongly abrasive, but, in addition thereto, is also still hot, whereby the material of the rake or of the baffle plates is additionally softened. In the final analysis, these mechanical spreading aids must be frequently replaced, for which an interruption of the continuous clinker production process is necessary and leads to a brief shutdown of the plant.

### SUMMARY OF THE INVENTION

The object of the invention is therefore to propose a grate cooler plate which overcomes the drawbacks of the prior art.

The inventive object is achieved by virtue of the fact that a rotatable insert having air passage openings is present in the surface of the grate cooler plate. Further advantageous embodiments of the invention are defined in the subclaims.

According to the invention, it is proposed to arrange in the grate cooler plate a rotatable insert through which cooling air flows.

The bulk material which is deposited onto the grate cooler is in a very loose state as a result of the through-flowing cooling air. This state is neither comparable with that of a loose bulk pile in the rest state, nor with the state of a fluidized bed in which the particles of a bulk pile are fluidized by a through-flowing carrier gas. Rather, the state of this bulk material layer, as a result of the cooling air which penetrates it, is particularly loose in relation to a bulk material layer deposited in the rest state and hence the bulk material layer is comparatively easily variable in terms of its shape. It has been established that a bulk material layer lying on a grate cooler can be influenced in terms of its formation of a material cone by varying the air inflow from below, in which case the angle of the material cone varies. The air inflow direction from below is here instrumental to the formation of a more or less flat bulk material cone, which by the continuous movement is distended into a roof-shaped bulk pile. The exact direction of the air inflow for the realization of a desired external shape of the bulk pile can here be determined by testing, for an outward pointing flow is not necessarily linked to a formation of a flat bulk pile and, conversely, an inward pointing flow is not necessarily linked to the formation of a more pointed bulk pile.

In order to achieve the ideal air feed direction from below into the bulk pile, the position of the rotatable insert in the grate cooler plate can be rotated during cold operation or in the rest setting until the desired angle of the material cone is formed.

The shape of the rotatable insert is variable according to the type of use. For an adjustment of the rotary position of the rotatable insert during operation, for instance by a remote control mechanism or by motorized adjustment, it is advantageous if the rotatable insert has a circular shape which is introduced into the surface of the grate cooler plate. The circular shape allows the rotatable insert to be continuously rotated in its seat during operation, since it is not necessary, for the rotation, to raise the rotatable insert from the insert counter to the gravitational force of the bulk material lying thereon.

For a preselected adjustment which shall no longer be subsequently changed, it is advantageous, on the other hand, if the rotatable insert has a regularly polygonal shape in the surface of the grate cooler plate. The regular polygonal shape means that the rotatable insert cannot be rotated within the surface of the grate cooler plate without it having to be raised counter to the gravitational force of the bulk material lying thereon. By virtue of the regularly polygonal shape, to which also a triangular, a quadratic or higher polygonal shape belongs, the rotatable insert is thus fixed in its position. In an extreme case, the shape of the rotatable insert can also be rectangular, elliptical or rhombic or have a symmetry which comprises a mirror plane or a dual rotational axis which enables the rotatable insert to be inserted in the grate cooler plate in two positions.

In order to increase the effect of the different air intake directions of the cooling air entering through the rotatable insert into the bulk material, it is advantageous if the rotatable insert has a preferential direction in the air discharge openings for the cooling air passing through the rotatable insert, wherein this preferential direction deviates from the vertical in relation to the surface of the grate cooler plate. As a result of the preferential direction which deviates from the vertical in relation to the grate plate surface, a horizontal directional component in relation to the surface of the grate cooler plate is imposed on the cooling air, which horizontal directional component can be used to form a more or less pointed bulk material cone. For if the rotatable insert has this preferential direction, the cooling air flowing obliquely into the cooling stock layer has the effect that, upon each stroke of the cooling grate for forward movement, bulk material to be cooled falls to the side and the pointed roof shape of the bulk material on the cooler which is to be cooled is thereby demolished in favor of a uniform layer thickness over the grate of the grate cooler.

In one embodiment of the invention, it is proposed that the rotatable insert have means by which the rotatable insert can be rotated from beneath the grate cooler plate. By way of example, a rod can be attached to the rotatable insert from beneath the cooling grate plane, which rod is reachable from beneath the cooling grate and by which the rotatable insert in the grate cooler plate can be rotated by manual or motorized means, in both cases directly or via a remote control linkage. The angle of the air passing out of the rotatable insert can hereby be adjusted even during operation. A circular shape allows the rotation without the rotatable insert having to be raised from its seat in the grate cooler plate. Insofar as the means for the rotation of the rotatable insert can apply a high force, it is also possible to raise the regularly polygonal, mirror-symmetrical or rotationally symmetrical rotatable insert from its seat in the grate cooler surface counter to the gravitational force of the bulk material lying thereon and to adjust the same.

In one embodiment of the invention, the rotatable insert can be inserted in an air feed duct for cooling air, which tapers to beneath the surface of the grate cooler plate. As a result of the tapered air feed duct, it is not possible for the rotatable insert to fall into its insert and for a leak to develop, for the bulk material to be cooled, on the grate cooler.

In order to offer little mechanical resistance to the bulk material moving over the grate cooler plate and to reduce the wear upon the grate cooler plate and the rotatable insert, it is provided that the rotatable insert terminates flush with the surface of the grate cooler plate.

In one particular embodiment of the invention, it is provided that the grate cooler plate, and also the rotatable insert, have material-holding depressions for the formation of an autogenous wear protection layer.

### BRIEF DESCRIPTION OF THE DRAWINGS

The invention is explained in greater detail with reference to the following figures.

FIG. 1 shows an inventive grate cooler plate with rotatable insert in a perspective view,

FIG. 2 shows a sectional view of the grate cooler plate with rotatable insert along the plane A-A from FIG. 1,

FIG. 3 shows the sectional view from FIG. 2 of the grate cooler plate with rotatable insert and with additional material-holding depressions.

### DETAILED DESCRIPTION OF THE PREFERRED EMBODIMENTS

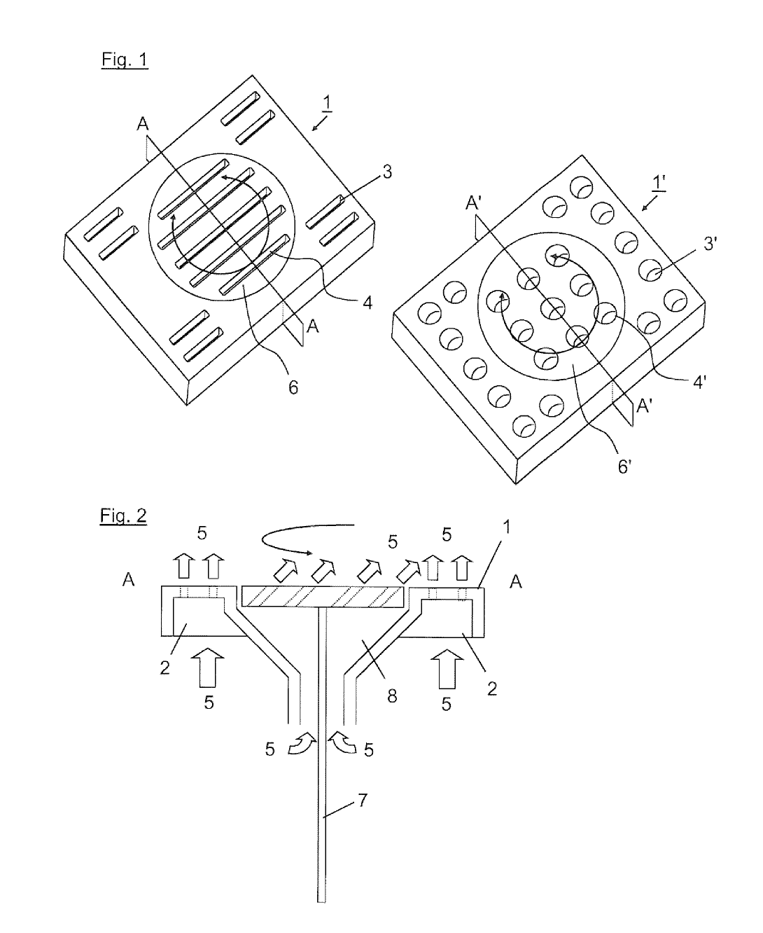

In FIG. 1 are represented, in a perspective view from above, two rectangular differently configured grate cooler plates 1, 1′, which each in this view have a concealed air inlet 2, 2′ and therewith corresponding, elongate air passage openings 3, 3′ oriented parallel to one side of the grate cooler plate 1, 1′, which air passage openings are disposed on the corners of the rectangular grate cooler plates 1, 1′ and through which cooling air 5, 5′ penetrates into the bulk material bed (not represented in this diagram) lying on the grate cooler plate 1, 1′. The grate cooler plates 1, 1′ have, in addition to the elongate air feed openings 3, 3′, in comparison to the upper surface of the grate cooler plate 1, 1′, a large central recess, in which there is respectively inserted a rotatable insert 6, 6′ which likewise has elongate air passage openings 4, 4′ for cooling air, wherein the cooling air penetrates into the bulk material (not represented in this diagram) lying on the grate plate surface. The rotatability of the rotatable insert 6, 6′ in the grate cooler plate 1, 1′ is indicated in FIG. 1 by a circular double arrow and has the effect that, when the rotatable insert 6, 6′ is rotated, the cooling air 5, 5′ flowing through the rotatable insert 6, 6′ penetrates into the bulk material to be cooled with a flow characteristic other than the cooling air 5, 5′ which penetrates through the fixed air passage openings 3, 3′ of the grate cooler plate 1, 1′ into the bulk material to be cooled, since the orientation of the air passage openings 3, 3′, 4, 4′ in the grate cooler plates 1,1′ and the rotatable inserts 6, 6′ are oriented differently. In the use of these thus configured grate cooler plates 1, 1′, it has been shown that the different orientation of the elongate various air passage openings 3, 3′ and 4, 4′ already leads to a different angle of the bulk material cone, which, when distended by movement of the bulk material cone, is transformed into a roof-shaped bulk pile.

The inner structure of the grate cooler plates 1, 1′ is represented in FIG. 2 by a sectional drawing along the sectional plane A-A or A′-A′ according to FIG. 1. It can be seen from FIG. 2 that the rotatable insert 6, 6′ is inserted in a tapered air feed duct 8 of the grate cooler plate 1, 1′ and —indicated by dashed lines—comprises air passage openings 4, 4′ which are angled-off from the perpendicular in relation to the surface of the grate plates 1, 1′ and through which cooling air passing through these air passage openings 4, 4′ has a horizontal directional component upon exit.

In one embodiment of the invention, it is provided that the rotatable insert 6, 6′ is rotatable by a rotational mechanism 7 from beneath the grate cooler plates 1, 1′. In the present example, the rotatable insert is externally movable by a rod 7 acting as the rotational mechanism, which rod initially projects into the tapered air feed duct 8 and from there leads out of the duct through a bush to the outside, where this rod can be used for the manual or motorized movement of the rotatable insert 6.

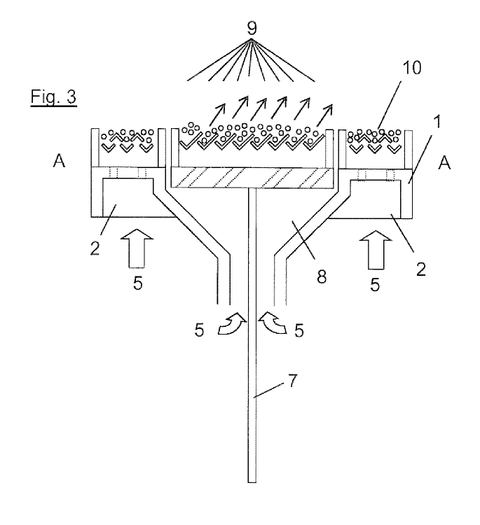

In one specific embodiment of the invention, it is provided according to FIG. 3 that the grate cooler plate 1 comprises material-holding depressions 9, to which reference is made in FIG. 3 by the fanned line under reference symbol 9 and in which bulk material to be cooled remains so as to form there an autogenous wear protection layer 10 which is immobile in relation to the grate cooler plate 1 and the material-holding depressions 9 and thus protects the grate cooler plate 1 and the rotatable insert from wear. In this specific embodiment of the invention, the material-holding depressions 9 are here arranged such that cooling air 5 which penetrates through the material-holding depressions 9 into the bulk material bed has a clear hoirizontal directional characteristic. It has been shown that this directional characteristic appears directly already upon use of a symmetrical floor of the material-holding depressions 9 in the rotatable insert 6, as this is present on the grate cooler plate 1 if the rotatable insert 6 is inserted in rotated arrangement in relation to the grate cooler plate 1 and is operated. However, this effect is more strongly pronounced in the case of a horizontal component of the cooling air 5.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

### REFERENCE SYMBOL LIST

1 grate cooler plate
1′ grate cooler plate
2 air inlet
3 air passage openings
3′ air passage openings
4 air passage openings
4′ air passage openings
5 air
6 rotatable insert
6′ rotatable insert
7 rotating means
8 air feed duct
9 material-holding depression
wear protection layer

1-10. (canceled)

11. A grate cooler plate including an air inlet and air passage openings through which flows air for cooling a cooling stock lying on the grate cooler plate, comprising
a rotatable insert having air passage openings in an upper surface of the grate cooler plate.

12. The grate cooler plate as claimed in claim 11, wherein the rotatable insert, in the upper surface, has one of a regularly polygonal and a circular shape.

13. The grate cooler plate as claimed in claim 11, wherein the air discharge openings of the rotatable insert have a preferential direction which deviates from perpendicular in relation to the surface of the grate cooler plate.

14. The grate cooler plate as claimed in claim 11, wherein the rotatable insert is constructed so as to be continuously rotatable in the upper surface of the grate cooler plate.

15. The grate cooler plate as claimed in claim 11, wherein the rotatable insert is constructed so as to be continuously rotated by a rotational mechanism from beneath the grate cooler plate.

16. The grate cooler plate as claimed in claim 15, wherein the rotational mechanism rotating the rotatable insert is arranged to be operated manually or by a motor.

17. The grate cooler plate as claimed in claim 11, wherein the rotatable insert is inserted in an air feed duct for cooling air, which is tapered beneath the upper surface of the grate cooler plate.

18. The grate cooler plate as claimed in claim 11, wherein an upper surface of the rotatable insert terminates flush with the upper surface of the grate cooler plate.

19. The grate cooler plate as claimed in claim 11, wherein the grate cooler plate comprises material-holding depressions to receive an autogenous wear protection layer.

20. A grate cooler for cooling bulk material, comprising
a grate cooler plate including an air inlet and air passage openings through which flows air for cooling a cooling stock lying on the grate cooler plate, and
a rotatable insert having air passage openings arranged in an upper surface of the grate cooler plate.
